(19) United States
(12) Patent Application Publication
(10) Pub. No.: US 2006/0170224 A1
(43) Pub. Date: Aug. 3, 2006

(54) Hood latch assembly

(76) Inventors: John Robert Scott Mitchell, Ontario (CA); Keith Allan Morgan, Ontario (CA); Jeffrey Richard F Domenchinl, Ontario (CA); Christopher L Larsen, Ontario (CA)

Correspondence Address: CLARK HILL, P.C., 500 WOODWARD AVENUE, SUITE 3500, DETROIT, MI, 48226, US

(21) Appl. No.: 10/545,724

(22) PCT Filed: Feb. 23, 2004
(86) PCT No.: PCT/CA04/00253

§ 371 Date: Aug. 16, 2005

Related U.S. Application Data
(60) Provisional application No. 60/449,369, filed on Feb. 21, 2003.

(51) Int. Cl. E05C 3/06

(52) U.S. Cl. 292/216; 292/DIG. 14

(57) ABSTRACT

A hood latch has a mounting plate, a ratchet and pawl assembly, a secondary release lever and a reinforcement plate. The mounting plate has a fishmouth. The ratchet is pivotally mounted to the mounting plate at a first pivot point. The ratchet cooperates with the fishmouth and moves between an unlatched position and a latched position. The ratchet is biased to the unlatched position. The pawl is pivotally mounted to the mounting plate at a second pivot point. The pawl is biased to engage the ratchet and releasably retain the ratchet in the latched position. The secondary release leveris pivotally mounted to the mounting plate at a third pivot point. The secondary release lever is moveable between a secondary latched position closing the fishmouth providing a secondary catch and a release position pivoted away from the fishmouth. The secondary release lever is biased to the secondary latched position. The reinforcement plate is fixedly secured to the mounting plate at each of the pivot points to cover the ratchet and pawl assembly. The reinforcement plate includes an alignment mechanism positioned to maintain the ratchet and pawl assembly in alignment with each other.

### FIELD OF THE INVENTION

This invention relates to a hood latch for a motor vehicle. More particularly, the invention relates to a hood latch designed to reduce bypass of a striker, and improve the strength of the primary and secondary catch.

### DESCRIPTION OF RELATED ART

A hood latch releaseably engages a striker to secure a hood of a motor vehicle. Typically, a hood latch is secured to a front portion of a vehicle body or a front end of the hood.

The strength of the hood latch may be compromised during striker “pull-out”, i.e., movement of the hood out from the closed position, due to the amount of force exerted thereon, particularly during collisions. These forces twist and pull at the hood latch decreasing the strength thereof.

Another common problem with a hood latch during striker “pull-out” is the lifting of the ratchet or the pawl relative to the other causing the ratchet to disengage from the pawl. This disengagement causes the latching function to fail and thereby allowing the hood to unexpectedly open.

The hood latch includes a secondary catch to hold the striker in a secondary closed position. The secondary catch is pivotally movable into and out of engagement with the striker. The secondary catch engages the striker when the hood latch has been released from its primary latched condition.

When the secondary catch is subject to loads originating from inside the engine compartment and directed forward, i.e., “fore and aft loads”, the secondary catch may weaken under the stress compromising its integrity.

### SUMMARY OF THE INVENTION

The disadvantages of the prior art may be overcome by providing a hood latch having improved strength characteristics to resist striker “pull out”.

According to one aspect of the invention, a hood latch is provided having a mounting plate, a ratchet pivotally mounted to the mounting plate at a first pivot point; and a pawl pivotally mounted to the mounting plate at a second pivot point. A reinforcement plate is fixedly secured to the mounting plate at each of the pivot points to cover the ratchet and the pawl. The reinforcement plate is also structurally connected to the mounting plate at at least a third securing point, thus lend additional stability to the hood latch.

According to another aspect of the invention, a hood latch is provided having a mounting plate, a ratchet pivotally mounted to the mounting plate, and a pawl pivotally mounted to the mounting plate. A secondary catch is also pivotally mounted to the mounting plate via a pin or rivet. The secondary catch includes a lever end designed to abut against the mounting plate when a fore load is exerted against the secondary catch.

According to another aspect of the invention, a hood latch is provided having a mounting plate, a ratchet pivotally mounted to the mounting plate, and a pawl pivotally mounted to the mounting plate. A reinforcement plate is fixedly secured to the mounting plate to cover the ratchet and the pawl. The ratchet and the pawl are each spaced apart from the mounting plate and the reinforcement plate so as to preclude the ratchet and pawl from binding to the plates during operation. However, each of the mounting plate and reinforcement plate includes a rib at a position where the ratchet and pawl inter-engage in order to locally reduce the clearance between the ratchet/pawl and the plates, to thereby maintain alignment between the ratchet and pawl.

According to yet another aspect of the invention, a hood latch is provided having a mounting plate, a ratchet and pawl assembly, a secondary catch and a reinforcement plate. The mounting plate has a fishmouth. The ratchet is pivotally mounted to the mounting plate at a first pivot point. The ratchet cooperates with the fishmouth and moves between an unlatched position and a latched position. The ratchet is biased to the unlatched position. The pawl is pivotally mounted to the mounting plate at a second pivot point. The pawl is biased to engage the ratchet and releasably retain the ratchet in the latched position. The secondary catch is pivotally mounted to the mounting plate at a third pivot point. The secondary catch is moveable between a secondary latched position closing the fishmouth and a release position pivoted away from the fishmouth. The secondary catch is biased to the secondary latched position. The reinforcement plate is fixedly secured to the mounting plate at each of the pivot points to cover the ratchet and pawl assembly. The reinforcement plate includes an alignment mechanism positioned to maintain the ratchet and pawl assembly in alignment with each other.

According to another aspect of the invention, there is provided a hood latch assembly having a catch. The secondary catch has a hook end and a lever end. The secondary catch is pivotally mounted intermediate of the hook and lever ends. The lever end will engage the mounting plate when bending moments are applied to the hook end and will resist such bending moments.

### BRIEF DESCRIPTION OF THE DRAWINGS

Advantages of the invention will be readily appreciated as the same becomes better understood by reference to the following detailed description when considered in connection with the accompanying drawings wherein:

FIG. 1 is a perspective view, partially cut away, of a front end of a motor vehicle showing a hood latch secured thereto and a hood in an open position;

FIG. 2 is a front, side view of the hood latch of one embodiment of the invention;

FIG. 3 is a partially exploded, perspective view of the hood latch shown in FIG. 2, with the exception of a secondary catch and various biasing springs which have been removed from the drawing for clarity of view;

FIG. 4 is a cross-sectional view taken along lines 4-4 of FIG. 3;

FIG. 5 is a perspective view of the hood latch assembly shown in FIG. 3;

FIG. 6 is a cross-sectional view taken along lines 6-6 of FIG. 5;

FIG. 7 is a cross-sectional view taken along lines 7-7 of FIG. 5;

FIG. 8 is a rear, side view of the hood latch shown in FIG. 2, showing a secondary catch with greater clarity; and

FIG. 9 is a perspective view of the hood latch shown in FIG. 2 from the side of the secondary catch.

### DETAILED DESCRIPTION OF THE PREFERRED EMBODIMENT

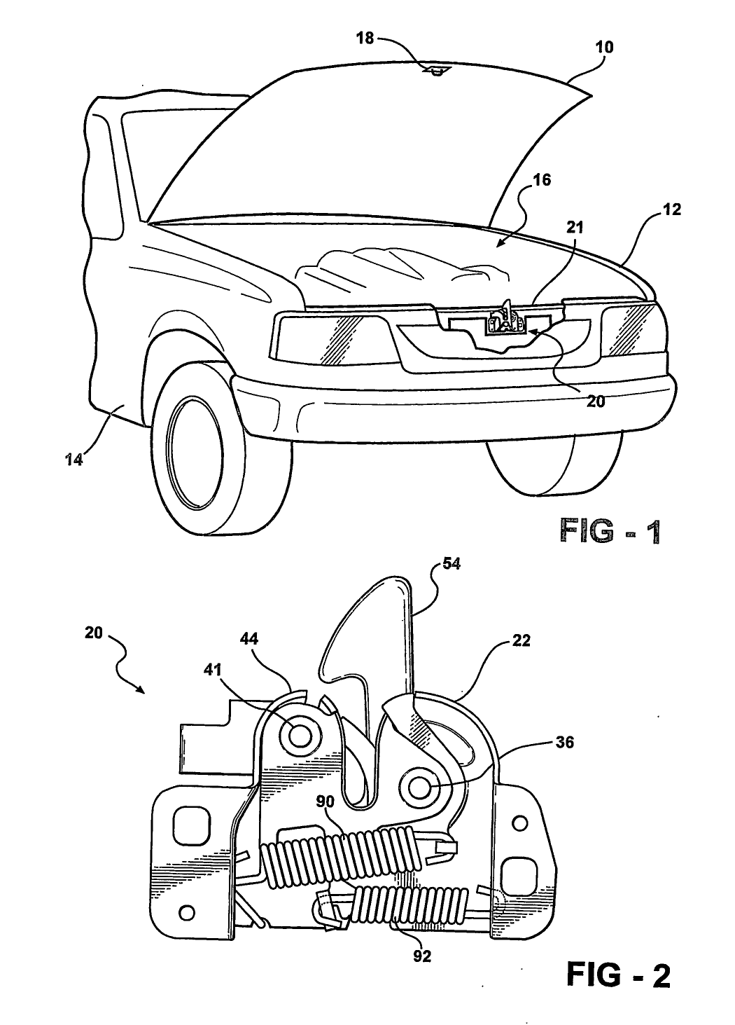

Referring to FIG. 1, a hood 10 is pivotally secured to a body 12 of a motor vehicle 14. The hood 10 is shown in an open position, in which an engine compartment 16 is exposed to allow access thereto for servicing. The hood 10 moves between a closed position covering the engine compartment and the open position. It is desirable to maintain the hood 10 in the closed position at all times except when access to the engine compartment 16 is desired.

A striker 18 is secured to the hood 10 and extends outwardly therefrom. The striker 18 is a generally U-shaped bar that is engaged by a hood latch, generally indicated at 20, to latch the hood 10 in the closed position. The hood latch 20 is secured to the body 12 at a front portion 21 thereof and is positioned so that the striker 18 will engage the hood latch 20 upon the hood 10 reaching the closed position. It is appreciated that, alternatively, the hood latch 20 may be secured to the hood 10 and the striker 18 may be secured to the body 12 of the motor vehicle 14.

Referring to FIGS. 2-4, one embodiment of hood latch 20 includes a mounting plate 22 that is contoured in a generally U-shape enabling attachment to the motor vehicle 14. The mounting plate 22 is contoured to define a generally planar mounting surface 24 and a plurality of apertures for attaching various components of the hood latch 20 thereto. The mounting plate 22 defines a fishmouth or slot 26 for receiving the striker 18 therein. Preferably, mounting plate is a stamped metal component.

The hood latch 20 includes a ratchet 28 and a pawl 30, both of which are pivotally secured to the mounting surface 24 of the mounting plate 22. The ratchet 28 includes a arm 32 and arm 34 spaced apart to define a generally u-shaped slot 31 therebetween. The ratchet 28 pivots about a pin rivet 36 that extends through an aperture 35. The ratchet 28 moves between an unlatched position for releasing the striker 18 and a latched position such that the striker 18 is received in the slot 31 and cooperates with the receiving slot 26 of the mounting plate 22. The ratchet 28 is biased to the unlatched position via a spring 90 (shown only in FIG. 2) connected to the mounting plate 22. The pawl 30 has an annular base 38 defining a pivot aperture 42. Arm 39 extends from the annular base 38. Detent 40 extends from the arm 39 and is positioned to engage with arm 32 of the ratchet 28 to releasably retain the ratchet 28 in the latched position. The pawl 30 is pivotally mounted by rivet 41 to the mounting plate 22. The pawl 30 is biased to engage the ratchet 28 via a second spring 92 (shown only in FIG. 2) connected to the mounting plate 22.

The pawl 30 has an arm 39 that cooperates with a remote release system such as a push-pull cable assembly as is commonly known in the art for actuating the pawl 30 during operation of the hood latch.

A reinforcement plate 44 is fixedly secured to the mounting plate 22 and covers the ratchet 28 and the pawl 30. The reinforcement plate 44 defines a plurality of apertures 46 through which the rivets 36, 41 extend. The pin rivets 36, 41 also secure the reinforcement plate 44 to the mounting plate 22.

The reinforcement plate 44 has fishmouth 45 corresponding in shape and position with fishmouth 26 of mounting plate 22. Preferably, fishmouth 45 has flanged edge 47 designed to improve rigidity of the plate 44.

The reinforcement plate 44 includes an alignment mechanism, generally shown at 48, to maintain the ratchet 28 and the pawl 30 in alignment vis-a-vis one another during striker pull out, i.e., movement of the striker 18 out of the latched position.

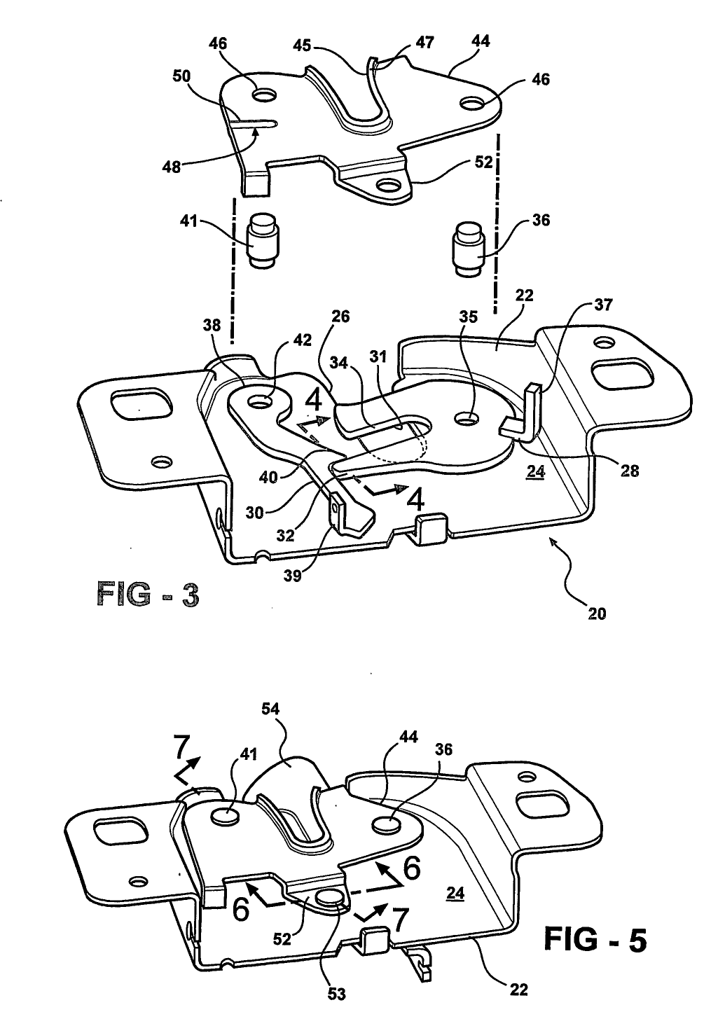

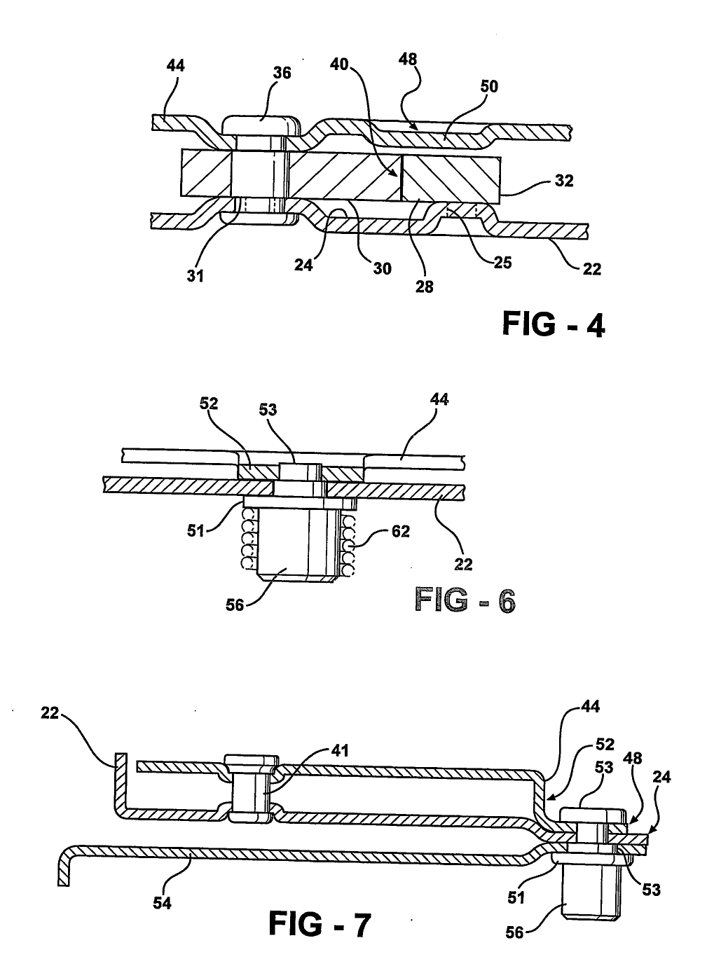

More specifically, referring particularly to FIGS. 3 & 4, the alignment mechanism 48 includes a formed rib 50 shaped and positioned to overlie the ratchet large arm 32 and the pawl tooth 40 to eliminate space therebetween that could allow the ratchet 28 and the pawl 30 to become misaligned and move away from each other (e.g., vertically, as shown in FIG. 4) during striker pull out. While the restricting rib 50 is shown in FIG. 4 to be formed as an indentation from a stamping process, it should be appreciated by those skilled in the art that the restricting rib 50 could be a fabricated piece secured to the reinforcement plate 44 after the fabrication thereof. A similarly opposing rib 25 is formed on mounting plate 22 to maintain the position of ratchet arm 32. Although not shown in FIG. 4 due to the angle of the cross-section taken in FIG. 3, the rib 25 also preferably overlaps the pawl tooth 40.

The restricting rib 50 reduces the clearance between the mounting plate 22 and the reinforcement plate 44 to a minimal clearance. Alignment of the ratchet 28 and the pawl 30 is maintained during normal operation and during “pull out” situations. The maximum strength of the latch is thus realized by maximizing the pawl-to-ratchet contact area. It should be appreciated that the mounting plate 22 and reinforcement plate 44 cannot abut the ratchet and pawl since that would otherwise cause these moving parts to bind to the housing. However, in operation, the ribs 25,50 have a small enough surface area to prevent binding problems.

Referring additionally to FIGS. 5-7, a tie-down leg 52 extends from the reinforcement plate 44 to the mounting surface 24 of mounting plate 22. Leg 52 is bent to engage surface 24 and maintain reinforcement plate 44 in a spaced position from surface 24. The tenon 53 of a rivet 56 secures the tie-down leg 52 of reinforcement plate 44 against mounting plate 22 at mounting surface 24. The tenon 53 thus passes through two metal stampings, which adds strength to the joint. The tie-down leg 52 combines with the pin rivets 36, 41 interconnecting the mounting plate 22 and the reinforcement plate 44 to lend additional stability to the hood latch 20. Acting as a third securing point, the tie-down leg 52 prevents the mounting plate 22 and the reinforcement plate 44 from twisting as the striker 18 is pulled away. Thus, the integrity of the hood latch 20 is strengthened as the mounting plate 22 and the reinforcement plate 44 can more completely provide support.

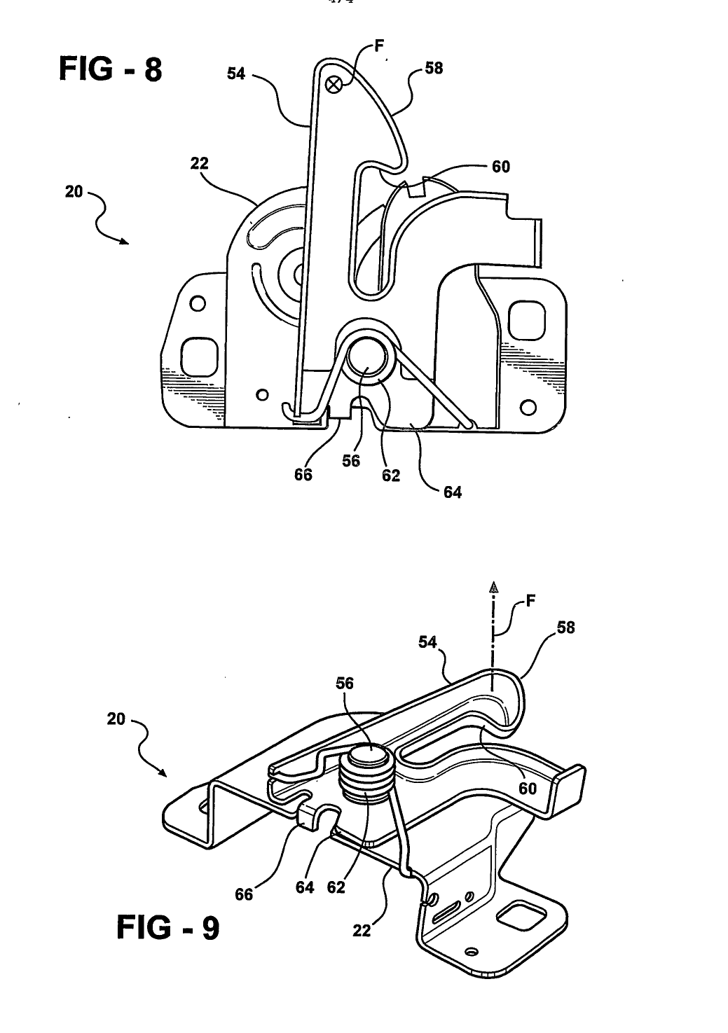

Referring additionally to FIGS. 8-9, a secondary release lever or catch 54 is pivotally secured to the mounting plate 22 and reinforcement plate 44 through a pin or axle such as provided by the rivet 56. The secondary catch 54 is mounted on the mounting plate 22 on a side opposite the ratchet 28 and pawl 30. The secondary catch 54 has a hook end 58 having a hook 60. A coil spring 62 extends between the mounting plate 22 and the secondary catch 54 biasing the secondary catch 54 into a position such that the hook 60 closes the fishmouth 26. After the striker is released from the pawl 28, the hook 60 engages and retains the striker 18 in the fishmouth 26.

The secondary catch 54 includes a lever end 64 that extends away from the rivet 56 and pivot point, opposite the hook 60. The lever end 64 is designed to abut against the mounting plate 22 when a fore load F is exerted against the secondary catch 54. During normal latch operations the lever end 64 does not abut against the mounting plate 22. However, under load, the abutment of the lever end 64 against the mounting plate 22 greatly reduces the bending moment on the secondary catch rivet 56 because the lever end transforms the bending moment into a substantially pure tensile extraction. Generally, a rivet is more resistant to such tensile forces than bending moments. In the preferred embodiment, the moment end 64 extends approximately 30 mm from the rivet 56.

The moment end 64 includes a turned limit flange 66 that engages the mounting plate 22 to prevent the secondary catch 54 from moving away from the receiving slot 26 a distance greater than the distance required to release the striker 18.

The invention has been described in an illustrative manner. It is to be understood that the terminology, which has been used, is intended to be in the nature of words of description rather than of limitation. Many modifications and variations of the invention are possible in light of the above teachings and therefore the invention may be practiced other than as specifically described.

What is claimed is:

1. A hood latch comprising:
a mounting plate having a fishmouth;
a ratchet pivotally mounted to said mounting plate at a first pivot point, said ratchet having a slot that cooperates with the fishmouth to move between an unlatched position and a latched position, said ratchet biased to the unlatched position;
a pawl pivotally mounted to said mounting plate at a second pivot point, said pawl biased to engage said ratchet to releasably retain said ratchet in said latched position;
a secondary catch pivotally mounted to said mounting plate at a third pivot point, said secondary catch moveable between a secondary latched position closing said fishmouth and a release position pivoted away from said fishmouth, said secondary catch being biased to secondary latched position; and
a reinforcement plate fixedly secured to said mounting plate at each of said pivot points to cover said ratchet and said pawl, said reinforcement plate including an alignment mechanism positioned to maintain said ratchet and said pawl in alignment with each other.

2. A hood latch according to claim 1 wherein said alignment mechanism includes a restricting rib extending from said reinforcement plate reducing clearance between said ratchet and pawl and said reinforcement plate.

3. A hood latch according to claim 2 wherein said alignment mechanism further includes a restricting rib extending from said mounting plate reducing clearance between said ratchet and pawl and said mounting plate.

4. A hood latch according to claim 1 wherein said secondary catch has a hook end and a lever end and said secondary catch is pivotally mounted intermediate said hood end and said lever end, wherein said lever end engages said mounting plate when bending moments are applied to said hook end.

5. A hood latch as set forth in claim 4 wherein said alignment mechanism includes a restricting rib extending from said reinforcement plate reducing clearance between said ratchet and pawl and said reinforcement plate.

6. A hood latch according to claim 5 wherein said alignment mechanism further includes a restricting rib extending from said mounting plate reducing clearance between said ratchet and pawl and said mounting plate.

7. A hood latch comprising:
a mounting plate;
a ratchet pivotally mounted to said mounting plate at a first pivot point;
a pawl pivotally mounted to said mounting plate at a second pivot point;
a reinforcement plate fixedly secured to said mounting plate at each of said pivot points to cover said ratchet and said pawl, characterized in that said reinforcement plate is structurally connected to said mounting plate at at least a third securing point.

8. A hood latch according to claim 7, wherein said reinforcement plate includes at least one tie down leg abutting said mounting plate and is secured thereto.

9. A hood latch comprising:
a mounting plate;
a ratchet pivotally mounted to said mounting plate;
a pawl pivotally mounted to said mounting plate; and
a secondary catch pivotally mounted to said mounting plate via a rivet or pin, characterized by a lever end designed to abut against the mounting plate when a fore load is exerted against the secondary catch.

10. A hood latch according to claim 9, wherein said secondary catch has a hook end opposite said lever end and said secondary catch is pivotally mounted intermediate said hood end and said lever end, wherein said lever end engages said mounting plate when bending moments are applied to said hook end.

11. A hood latch comprising:
a mounting plate;
a ratchet pivotally mounted to said mounting plate;
a pawl pivotally mounted to said mounting plate;
a reinforcement plate fixedly secured to said mounting plate to cover said ratchet and said pawl, wherein each of said ratchet and said pawl are spaced apart from said mounting plate and reinforcement plate so as to preclude the ratchet and pawl from binding to said plates during operation;
characterized in that each of the mounting plate and reinforcement plate includes a rib at a position where said ratchet and pawl inter-engage in order to locally reduce the clearance between said ratchet and pawl and said plates, to thereby maintain alignment between said ratchet and said pawl.
